(19) United States
(12) Patent Application Publication
(10) Pub. No.: US 2012/0140436 A1
(43) Pub. Date: Jun. 7, 2012

(54) SOLID-STATE LAMPS WITH LIGHT GUIDE AND PHOTOLUMINESCENCE MATERIAL

(75) Inventors: Haitao Yang, San Jose, CA (US); Yi-Qun Li, Danville, CA (US); Ian Collier, Hayward, CA (US)

(73) Assignee: INTEMATIX CORPORATION, Fremont, CA (US)

(21) Appl. No.: 13/309,477

(22) Filed: Dec. 1, 2011

Related U.S. Application Data
(60) Provisional application No. 61/419,080, filed on Dec. 2, 2010.

(51) Int. Cl. F21V 13/02; F21V 8/00; F21V 9/16

(52) U.S. Cl. 362/84; 362/311.01; 362/235; 362/307

(57) ABSTRACT

A solid-state lamp comprises a light guide having at least one light emitting face and at least one solid-state light source (LED) configured to couple light into the light guide. The lamp further comprises a pattern of light extracting features for promoting emission of light from the light guide wherein the pattern of light extracting features is formed on at least one face of the light guide.

### CROSS-REFERENCE TO RELATED APPLICATIONS

This application claims the benefit of priority to U.S. Provisional Application No. 61/419,080, filed Dec. 2, 2010, entitled “Solid-state lamps with light guide and photoluminescent material” the specification and drawings of which are incorporated herein by reference in its entirety.

### BACKGROUND OF THE INVENTION

1. Field of the Invention

This invention relates to solid-state lamps with a light guide and photoluminescence material. In particular, although not exclusively, the invention concerns lamps based on LEDs (Light Emitting Diodes).

2. Description of the Related Art

White light emitting LEDs (“white LEDs”) are known and are a relatively recent innovation. It was not until LEDs emitting in the blue/ultraviolet part of the electromagnetic spectrum were developed that it became practical to develop white light sources based on LEDs. As taught, for example in U.S. Pat. No. 5,998,925, white LEDs include one or more photoluminescence (e.g. phosphor) materials, which absorb a portion of the radiation emitted by the LED and re-emit light of a different color (wavelength). Typically, the LED chip or die generates blue light and the phosphor material(s) absorbs a proportion of the blue light and re-emits yellow light or a combination of green and red light, green and yellow light, green and orange or yellow and red light. The portion of the blue light generated by the LED that is not absorbed by the phosphor material combined with the light emitted by the phosphor material(s) provides light which appears to the eye as being white in color.

Due to their long operating life expectancy (>50,000 hours) and high luminous efficacy (80 lumens per watt and higher) high brightness white LEDs are increasingly being used to replace conventional fluorescent, compact fluorescent and incandescent light sources.

Conventionally the powdered phosphor material is mixed with a light transmissive liquid binder, typically a silicone or epoxy, and the mixture applied directly to the light emitting surface of the LED die such that the LED die is encapsulated with phosphor material. Applications requiring high emission radiances such as general lighting, automobile headlights etc require the use of high input power LED dies, typically 1 W and higher. For a phosphor encapsulated LED the high operating temperature of the LED can degrade the phosphor resulting in reduced optical efficiency, a color shift in the emitted light and a shortened lifetime. For example for a phosphor encapsulated LED operating at 100° C. the amount of phosphor (photoluminescence) generated light can fall by about 10% compared with the phosphor encapsulated LED operating at 60° C. To overcome the problem of phosphor thermal degradation it is known to provide the phosphor remote to the LED die, that is physically separated from the LED die, to prevent or at least reduce the transfer of heat to the phosphor. Such light emitting devices and lamps will be termed “remote phosphor” devices in this patent specification.

U.S. Pat. No. 7,070,300 B2, “Remote wavelength conversion in an illumination device”, disclose an illumination device in which a wavelength converting element, typically a phosphor layer, is physically separated from the light source (LED) used to excite the element. To prevent converted light emitted by the element being incident on the light source the wavelength converting element is optically separated from the LED by a color separation element, dichroic element, disposed between the light source and wavelength converting element.

As disclosed in United States patent application US 2008/02118992 A1 to Li, the phosphor material can be provided as a layer on, or incorporate within an, optical component that is located remotely to the LED die. The remote phosphor can be located in a lower temperature environment and separated from the LED die by an air gap or other optical medium resulting in a higher optical efficiency, color stability and longer lifetime.

The inventor has appreciated that a challenge for remote phosphor devices is uniformly illuminating the surface of the remote phosphor with light from the LED die(s) to ensure a uniform light emission intensity and color. Since an LED approximates to a point source this can result in hot spots corresponding to the location of the LED(s). To overcome this problem it is known to use a diffuser to increase the uniformity of the emitted light. Whilst the use of a diffuser can improve emission uniformity it reduces the overall emission radiance and luminous efficacy of the device.

Light guides (waveguides) have been used to convert highly localized (usually point or linear) light sources to a uniform luminance surface. For example light is coupled into one or more edges of a planar light guide and is then guided by total internal reflection throughout the volume of the light guide and emitted from a light emitting face of the light guide. Such arrangements have been used with white LEDs as a backlight for liquid crystal displays (LCD) such as cellular telephone displays. It is also known to use a light guide to provide uniform illumination of a remote phosphor sheet (layer) covering the light emitting face of the light guide. In such devices it is necessary to have an air (or other low refractive index media) gap between the light guide and phosphor sheet for the light guide to operate. However the inventor has discovered that having an air gap between the light guide and phosphor layer lowers the absorption efficiency of blue light by the phosphor material resulting in a lower overall optical efficiency.

It is an object of the present invention to provide a solid-state lamp with a light guide and a remote phosphor that at least in part overcomes the limitations of the known devices.

### SUMMARY OF THE INVENTION

Embodiments of the invention concern solid-state lamps comprising a light guiding medium (light guide) having on at least one surface a pattern of light extracting features. In some embodiments, the invention is characterized by the light extracting features comprising at least one photoluminescence (e.g., phosphor) material that is deposited, typically by printing, as a pattern of features directly on a face of the light guide. In this patent specification “directly” means in contact with the face of the light guide and without the presence of any intervening layers or an air gap. Since the phosphor features provide both the mechanisms for extracting light from the light guide and converting light to different wavelength this eliminates the need for additional light extracting or scattering features. Since the phosphor is deposited directly on the light guide surface this eliminates the optical losses otherwise associated with light traveling through the light guide-air and air-phosphor interfaces thereby increasing the optical efficiency of the lamp.

According to some embodiments, a solid-state lamp comprises: a light guide having at least one light emitting surface; at least one solid-state light source configured to couple light into the light guide; and a pattern of features of at least one phosphor material for promoting emission of light from the substrate wherein the pattern of phosphor material is deposited directly to at least one face of the substrate. The pattern of phosphor features can be provided, preferably by printing, on the light emitting face, the opposite face or both faces of the light guide. The phosphor material, which is typically in powder form, is mixed with a light transmissive binder material, such as an acrylic, silicone material or a clear ink, and the slurry is then deposited on the face of the light guide. To optimize the extraction of light at the location of the phosphor material features the light transmissive binder is selected to have an index of refraction that is substantially equal to or greater than that of the light guide.

Typically the total area of all of the phosphor material features is less than about 20% of the area of the light emitting face and more typically less than about 10% of the area of the light emitting face.

To achieve a desired emission characteristic the pattern of phosphor material features can be configured at least in part in dependence on a light intensity distribution within the light guide which can be calculated or derived empirically. For example the spacing, size, shape and/or number of phosphor material features per unit area can be configured to depend on the distance from the at least one solid-state light source. Where a substantially uniform emission characteristic is required, the spacing of the phosphor material features will typically decrease with increasing distance from the light source whilst the size and/or number of phosphor features will increase with increasing distance from the light source.

The phosphor material features can comprise lines; substantially circular features; substantially elliptical features; substantially square features; substantially rectangular features; substantially triangular features; substantially hexagonal features; substantially polygonal shaped features; or combinations thereof. The pattern of phosphor material features can be regular or comprise a stochastic pattern. In one arrangement the pattern of phosphor material is configured as a first order stochastic pattern comprising a pseudo random array of dots of substantially the same size. Alternatively the pattern of phosphor material can be configured as a second order stochastic pattern comprising a pseudo random array of dots of varying size. In another arrangement the pattern of phosphor material can be configured as a half tone pattern comprising a regular array of dots of varying size.

In applications where it is required for the lamp to emit light from a single face, the lamp preferably further comprises a light reflective surface overlaying substantially the entire opposite face of the light guide. In lamp having a pattern of phosphor material features on the opposite face, the light reflective surface is configured to overlay the pattern of phosphor material.

Alternatively the lamp can be configured such that in operation light is emitted from opposite faces of the light guide. In such lamps a pattern of phosphor material features can be provided on one or both faces of the light guide.

The light guide can be substantially planar in form and be square, rectangular or circular in shape. Alternatively it can depending on application comprise other shapes such as being triangular, hexagonal, polygonal, circular or oval in form. The light guide can further comprise non-planar geometries such as being cylindrical or rod light in form. The light guide can comprise any material that is transmissive to visible light and preferably comprises a polymer such as a polycarbonate or an acrylic or a glass.

Embodiments of the invention concern solid-state lamps comprising a light guiding medium (light guide or waveguide) having at least one light emitting surface in which light is coupled into the medium such that it is guided, by total internal reflection, throughout the volume of the medium. The light guide includes a pattern of light extracting features on at least one surface and/or face, from which light is extracted from the light guide and emitted as the final light emission product.

In some embodiments, the solid-state light emitters which typically comprise LEDs are configured as an array with their emission axes substantially perpendicular to the plane of the light guide. The light can be coupled into a rear face (i.e. the face opposite the front light emitting face) of the light guide. The light guide can comprise a planar configuration (e.g., having a circular or elliptical disc shape, rectangular plane shape, square plane shape, triangular or other polygonal shapes) with the LEDs being circumferentially space around the edge of the light guide. To increase the uniformity of light emission the pattern of light extracting features can comprise concentric patterns of features in which the spacing between feature patterns decreases towards the center of the light guide. In addition, the size of the features can additionally increase towards the center of the light guide. The features can comprise can comprise lines; substantially circular features; substantially elliptical features; substantially square features; substantially rectangular features; substantially triangular features; substantially hexagonal features, substantially polygonal shaped features or combinations thereof. In one arrangement the features can comprise circular dots. The pattern of the light extracting features can be configured to minimize variation in the emission intensity over the entire face of the light guide.

The plurality of LEDs can be mounted as an array on a MCPCB (metal core printed circuit board). In some embodiments, the MCPCB comprises a layered structure composed of a metal core base, typically aluminum, a thermally conducting/electrically insulating dielectric layer and a copper circuit layer for electrically connecting electrical components in a desired circuit configuration, where the metal core base of the MCPCB is mounted in thermal communication with the base of the body with the aid of a thermally conducting compound such as for example an adhesive containing a standard heat sink compound containing beryllium oxide or aluminum nitride. The body can be constructed to incorporate and/or act as a heat sink having a planar upper surface and a plurality of heat radiating fins on an opposite face.

The edge of the light guide can be configured such that light emitted by the LEDs are redirected inwardly through the light guide. For example, the edge of the light guide can be configured to be curved or rolled from the rear face to the front face, and can be covered with a light reflective material such as chromium, aluminum or a light reflective paper or plastics material. The edge of the light guide can also be configured to slant inwardly from the rear face to the front face as a beveled edge that is covered with a light reflective material such as chromium, aluminum or a light reflective paper or plastics material. It will be appreciated that the edge(s) of the light guide can be configured with other geometries to ensure that light that is coupled into the face is redirected by the edge(s) into the volume of the light guide. The light reflective edge(s) can be configured to prevent light being emitted from the front face of the light guide that would otherwise be transmitted directly through the guide.

Locating the LEDs around the periphery of the light guide provides numerous advantages, such as heat management advantages and also minimizes component count in the optics, heat sink and electronics, thereby minimizing manufacturing costs.

Some embodiments provide an arrangement using non-remote-phosphor lamps that employ white LEDs, where the white LEDs are formed using powdered phosphor material that is mixed with a light transmissive liquid binder, typically a silicone or epoxy, and where the mixture is applied directly to the light emitting surface of the LED die such that the LED die is encapsulated with phosphor material. Since the phosphor material is not remote to the LED, this approach does not need phosphor materials deposited onto the light guide to generate white light. However, light extracting features will still be provided onto at least one surface of the light guide to allow the white light generated by the white LEDS to emit from the light guide. These light extracting features are configured to cause a difference in the refractive properties of the light extracting features as compared to the light guide itself. This allows white light emitted from the LEDs to escape the light guide if directed at the light extracting features at appropriate emission angles.

The light extracting features may be integrally formed onto the light guide material, e.g. by molding certain structures into the light guide from which light may be extracted from the light guide. Such features can extend into the surface or project from the surface of the light guide and examples of such features can include hemispherical or pyramidal indents or projections, grooves or ridges. In addition, the light extracting features may be formed by treating the surface of the light guide at specified locations. For example, the surface of the light guide may be treated by removing materials from the light guide surface, modifying the property of the light guide material, or depositing additional materials onto the light guide surface.

Another embodiment of the LED lamp is generally configured as a cylindrical structure, having a lower body that is formed as a linearly extending partial-cylindrical shape between two circular end units. The body can be of a hollow or solid construction and can be fabricated from any suitable sheet material, such as sheet metal, cast metal or a molded plastics material. A light guide is also formed as a linearly extending partial-cylindrical shape between the two circular end units. LEDs are mounted in the end units, where each LED is configured with its emission axis parallel with the plane of the light guide. The pattern of phosphors on the light guide can comprise parallel patterns of dots in which the spacing between parallel patterns decreases towards the center of the light guide. Moreover, the size of the dots can additionally increase towards the center of the light guide. Typically the phosphor pattern is configured to minimize variation in the emission intensity over the entire face of the light guide.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

In order that the present invention is better understood solid-state lamps in accordance with embodiments of the invention will now be described, by way of example only, with reference to the accompanying drawings in which like reference numerals are used to denote like parts, and in which:

FIG. 1 are plan and cross sectional views of a LED panel lamp incorporating an LED lamp in accordance with an embodiment of the invention;

FIG. 2 is a partially exploded perspective view of the LED lamp of FIG. 1;

FIG. 3 are plan and cross sectional views of the LED lamp of FIG. 2;

FIG. 4 is a schematic illustrating the principle of operation of an LED lamp in accordance with an embodiment of the invention;

FIG. 5 is a schematic illustrating the principle of operation of an LED lamp in accordance with an embodiment of the invention;

FIG. 6 is a schematic cross sectional view of an LED lamp in accordance with an embodiment of the invention;

FIG. 7 is a schematic cross sectional view of an LED lamp in accordance with an embodiment of the invention;

FIG. 8 is a schematic cross sectional view of an LED lamp in accordance with an embodiment of the invention;

FIG. 9 is a partially exploded perspective view of an LED lamp in accordance with an embodiment of the invention;

FIG. 10 is a partially exploded perspective view of an LED lamp in accordance with an embodiment of the invention;

FIG. 11 is a schematic cross sectional view of the LED lamp of FIG. 10 through a line A-A;

FIG. 12 is a schematic cross sectional view of the LED lamp of FIG. 10 illustrating operation of the lamp;

FIG. 13 is a partially exploded perspective view of an LED lamp in accordance with another embodiment of the invention;

FIG. 14 is a schematic cross sectional view of the LED lamp of FIG. 13 through a line A-A;

FIG. 15 is a schematic cross sectional view of the LED lamp of FIG. 13 illustrating operation of the lamp;

FIG. 16 are plan and cross sectional views of an LED lamp in accordance with an embodiment of the invention;

FIG. 17 is a schematic cross sectional view of the LED lamp of FIG. 16 illustrating operation of the lamp;

FIGS. 18a, 18b, 18c, and 18d are cross sectional views showing the operation of various embodiments of an LED lamp according to some embodiments of the invention;

FIG. 19 shows perspective and cross sectional views of a LED lamp in accordance with an embodiment of the invention;

FIG. 20a is a phosphor pattern based on AM (amplitude modulated) half tone screening; and

FIG. 20b is a phosphor pattern based on a first order stochastic or FM (frequency modulated) screening.

### DETAILED DESCRIPTION OF THE INVENTION

Embodiments of the invention concern solid-state lamps comprising a light guiding medium (light guide or waveguide) having at least one light emitting surface in which light is coupled into the medium such that it is guided, by internal reflection, throughout the volume of the medium. The light guide includes a pattern of light extracting features on at least one surface and/or face, from which light is extracted from the light guide and emitted as the final light emission product.

The light extracting features may be integrally formed onto the light guide material, e.g. by molding certain structures into the light guide from which light maybe extracted from the light guide. In addition, the light extracting features may be formed by treating the surface of the light guide at specified locations. For example, the surface of the light guide may be treated by removing materials from the light guide surface, modifying the property of the light guide material, or depositing additional materials onto the light guide surface.

Some embodiments pertain to an LED lamp in which the light source comprises blue LED lights, and in which the light guide is configured to include a pattern of photoluminescence materials as the light extracting features. The photoluminescence materials may be integrally formed into the light guide or, more preferably, is deposited onto a surface of the light guide. In some embodiments, the photoluminescence materials comprise phosphor. For the purposes of illustration only, the following description is made with reference to photoluminescence materials embodied specifically as phosphor materials. However, the invention is applicable to any type of photoluminescence material, such as either phosphor materials or quantum dots. A quantum dot is a portion of matter (e.g. semiconductor) whose excitons are confined in all three spatial dimensions that may be excited by radiation energy to emit light of a particular wavelength or range of wavelengths. As such, the invention is not limited to phosphor based wavelength conversion components unless claimed as such.

The phosphor is deposited, typically by printing, as a pattern of features directly on at least one face of a light guide. In this patent specification “directly” means in contact with and without the presence of any intervening layers or an air gap. In such configurations light is emitted preferentially from the light guide at the location of the phosphor material features thereby eliminating the need for additional light extracting or scattering features. In embodiments of the invention the phosphor material serves as both the mechanism for extracting light from the light guide and converting light to different wavelength through a photoluminescence conversion process. In operation excitation light that is extracted from the light guide by the phosphor material features will be absorbed directly by phosphor material and converted to light of a different color. Since the phosphor material is deposited directly on the light guide surface, that is there is no air gap between the phosphor material and light guide, this eliminates the optical losses associated with light traveling through a light guide-air and an air-phosphor interfaces thereby increasing the optical efficiency of the lamp.

Light extraction by the phosphor material features can be optimized by ensuring that there is good coupling of light from the light guide to the phosphor material features. This can be achieved by combining the phosphor material with a light transmissive binder that has an index of refraction (in a cured state) that closely matches or is greater than that of the light guide.

Since light is preferentially emitted at the location of the phosphor material features, the pattern can be configured to minimize the variation in emitted light intensity over the light emitting face of the light guide; that is, the pattern of phosphor features can be configured to promote a substantially uniform light emission intensity and/or color from the entire surface of the light guide. In this patent specification “substantially uniform” means that the variation in intensity is typically less than 25% and is preferably 10% or lower. Conversely it is envisioned to configure the pattern of phosphor material to produce a selected non-uniform emission profile.

The light guide can be planar and is typically square, rectangular, circular or elliptical in form with light being coupled into at least one edge of the light guide. Alternatively light can be coupled into the face of the light guide opposite the light emitting face around the periphery of the light guide. To prevent the emission of light directly from the light emitting face, the edge(s) of the light guide can be beveled and include a light reflective surface. In such arrangements the beveled edge(s) of the light guide reflects excitation light into the light guide and prevents excitation light being emitted directly from the light emitting face. In other embodiments the light guide can have other geometries such as being cylindrical or rod like in form with light being coupled into one or both ends of the rod. In such arrangements the light emitting face can comprise a part or whole of the curved surface of the light guide.

A lighting fixture commonly found in offices and commercial premises is a fluorescent lighting panel. Generally, such lighting panels comprise a light box comprising an enclosure housing one or more fluorescent tubes and a front diffusing panel. Typically, the diffusing panel is a translucent plastics material or a transparent plastics material with a regular surface patterning to promote a uniform light emission. Alternatively, a louvered front cover can be used to diffuse the emitted light. Such lighting panels are often intended for use in a suspended (drop) ceiling in which a grid of support members (T bars) are suspended from the ceiling by cables and ceiling tiles supported by the grid of support members. The ceiling tiles can be square or rectangular in shape and the lighting panel module is configured to fit within such openings with the diffusing panel replacing the ceiling tile.

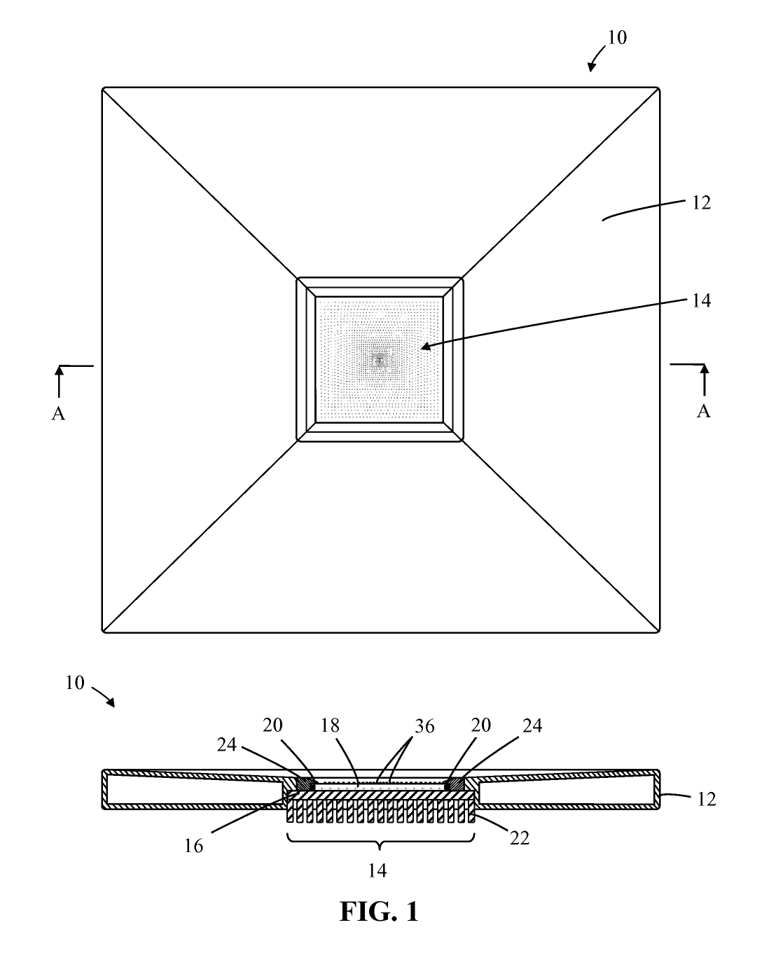

FIG. 1 shows plan and sectional views of an LED-based lighting panel 10 in accordance with an embodiment of the invention. The lighting panel 10 is intended to be an energy efficient replacement for a fluorescent lighting panel and comprises a body 12 in the form of a square tile and an LED lamp 14. The body can be of a hollow or solid construction and can be fabricated from sheet material such as sheet metal, cast metal or a molded plastics material. Essentially the body 12 is decorative and can be configured for a particular application. For example the body 12 can be configured to enable the lighting panel 10 to be mounted within a square aperture of a suspended ceiling. In such applications the body is typically configured as a twelve inch square tile.

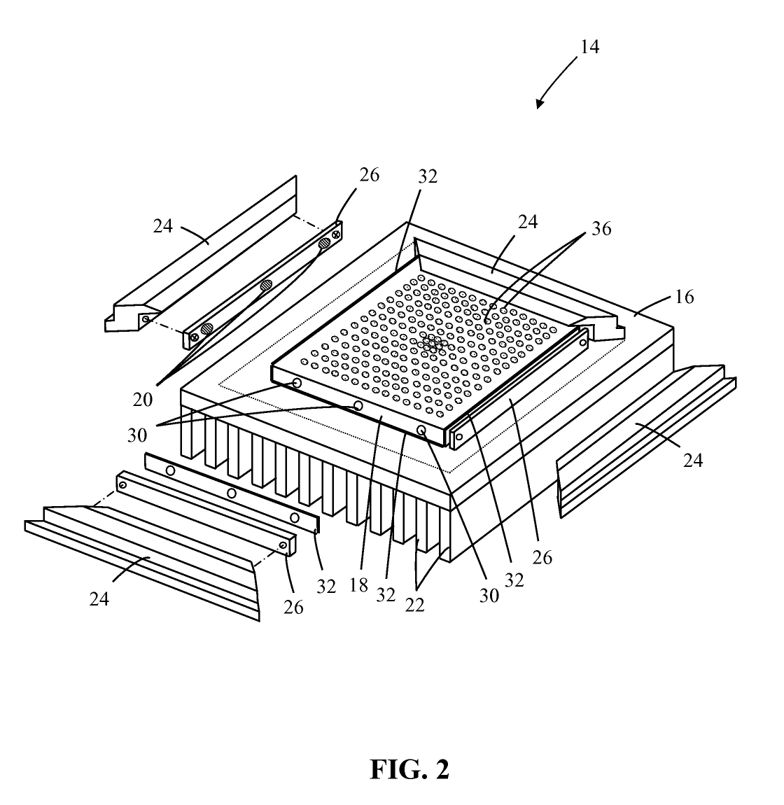

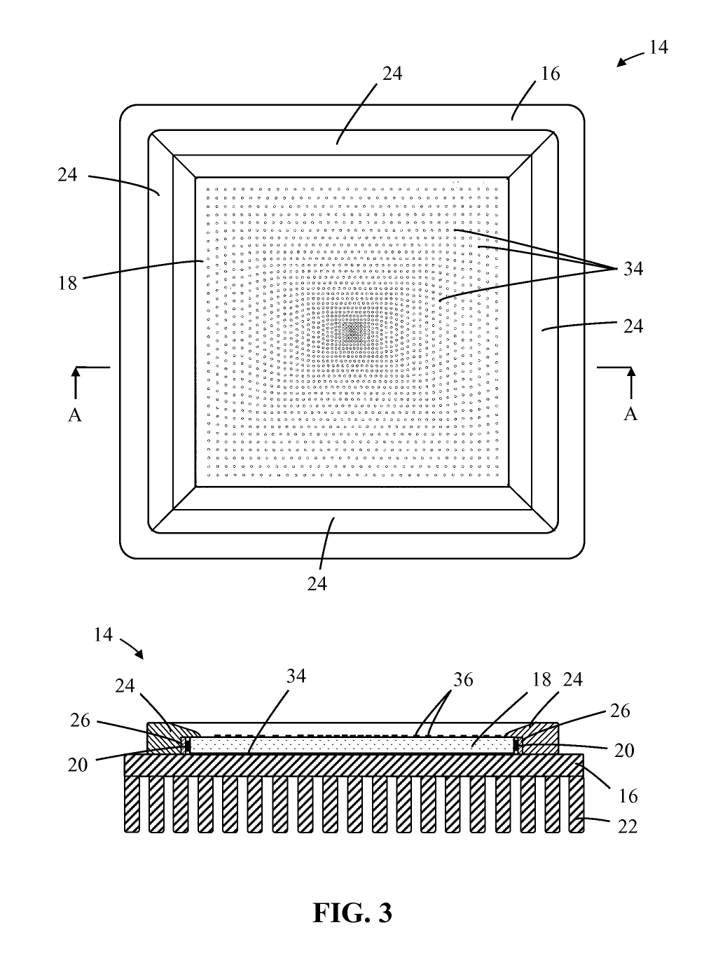

The LED lamp 14 is now described with reference to FIG. 2 which is a partially exploded perspective view of the lamp and FIG. 3 which shows plan and cross sectional views of the lamp. The lamp 14 comprises a thermally conductive body 16, a planar light transmissive light guide 18 and a plurality (twelve in this example) blue light emitting LEDs 20 (blue LEDs).

The body 16 can as shown comprise a square heat sink having a planar upper surface and a plurality of heat radiating fins 22 on an opposite (lower as shown) face. The body 16 is preferably fabricated from aluminum, an alloy of aluminum or any material with a high thermal conductivity (typically κ≧150 Wm⁻¹K⁻¹ and preferably ^{κ}≧200 Wm⁻¹K⁻¹) such as for example copper, a magnesium alloy, a metal loaded plastics material or a thermally conductive ceramic such as aluminum silicon carbide (AlSiC). The lamp 14 further comprises a thermally conductive frame 24, which as indicated can comprise four mitered members, which are mounted in thermal communication with the planar face of the body 16. The frame is configured in conjunction with the body to house the light guide 18 and LEDs 20.

The light guide 18 can be constructed from any material which is transmissive (transparent) to visible light (380 nm to 470 nm) and typically comprises a sheet plastics material such as a polycarbonate, an acrylic or a glass. In the example illustrated the light guide 18 comprises a 75 mm square polycarbonate plate of 5 mm thickness.

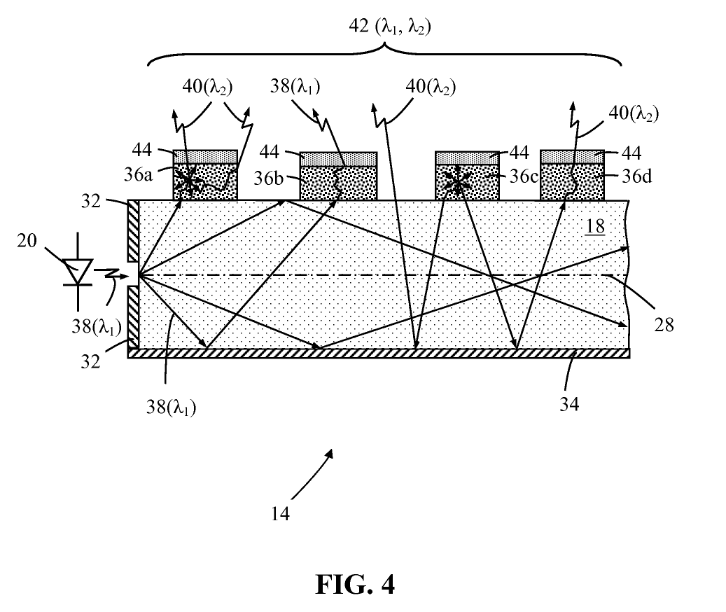

The blue LEDs 20 can comprise GaN-based (gallium nitride-based) LEDs that are operable to generate blue light having a peak wavelength λ₁ in a wavelength range 400 nm to 480 nm (typically 450 nm to 470 nm). The LEDs 20 are mounted in groups of three as a linear array on a respective strip of MCPCB (metal core printed circuit board) 26. Each MCPCB 26 is configured to run along a respective edge of the light guide such that excitation light generated by the LEDs 20 is coupled into a respective edge of the light guide 18. The LEDs are configured such that their emission axis 28 is parallel with the plane of the light guide (FIG. 4). As indicated the LEDs are typically equally spaced along each edge of the light guide 18. The edge of the light guide 18 corresponding to each LED can include a generally hemispherical (dish-shaped) indentation 30 (FIG. 2) to assist in coupling light into the light guide. To prevent the escape of blue light, the edges of the light guide can include a light reflective (mirrored) coating 32 (FIG. 2) such as for example a metal foil. To ensure that light emitted from the lower face will be reflected back into the light guide and emitted from the upper light emitting face of the light guide, the lower face of the light guide, that is the face opposite the light emitting face, is covered with a high reflectance white sheet 34 (indicated by a solid line FIG. 2). The rear face of each MCPCB 26 is mounted in thermal contact with the frame 24 with the aid of a heat sink compound.

The lamp 14 further comprises at least one phosphor material 36 that is deposited directly on the light emitting (upper) face of the light guide in the form of a selected pattern. As is best seen in FIG. 3 the pattern of phosphor material comprises 0.5 mm diameter circular features (dots) that are configured as a series of nested squares in which the density of dots (number of dots per unit area) increases from the light guide edge to the center. The pattern of phosphor material dots 36 is configured to minimize variation in emitted light intensity over substantially the entire surface of the light emitting face, that is the pattern of phosphor features promotes a substantially uniform extraction of light over the entire surface of the light guide. Typically the proportion of the light guide face area covered by the phosphor material is less than 50%. More preferable, the area percentage is less than 20%, or 10%. In the embodiment illustrated in FIG. 3 the total area of printed phosphor material is about 7% of the area of the light guide face. A particular benefit of the LED lamp 14 of the invention is the significant cost saving compared with the known remote phosphor devices in which the phosphor material covers the whole luminescence surface. It is noted that the size, number, shape, and/or configuration of phosphor features shown in these figures are provided merely as an illustrative aid in explaining the embodiments of the invention, and are not necessarily drawn to actual scale or with precision as to the exact size, number, shape, or configuration of features.

The phosphor material 36, which is in powder form, is thoroughly mixed in known proportions with a liquid binder material to form a suspension and the resulting phosphor composition, “phosphor ink”, deposited onto the face of the light guide 18, e.g. by screen printing, inkjet, letterpress, gravure or flexograph printing. The liquid binder material can comprise a U.V. or thermally curable liquid polymer such as a U.V. curable acrylic adhesive or silicone. To ensure efficient extraction of light at location of the phosphor features the binder material is selected to have, in a cured state, an index of refraction that closely matches or is greater than the index of refraction of the light guide 18.

The phosphor material can comprise an inorganic or organic phosphor such as for example silicate-based phosphor of a general composition A₃Si(O,D)₅ or A₂Si(O,D)₄ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S). Examples of silicate-based phosphors are disclosed in U.S. Pat. No. 7,575,697 B2 “Silicate-based green phosphors” (assigned to Intematix Corp.), U.S. Pat. No. 7,601,276 B2 “Two phase silicate-based yellow phosphors” (assigned to Intematix Corp.), U.S. Pat. No. 7,655,156 B2 “Silicate-based orange phosphors” (assigned to Intematix Corp.) and U.S. Pat. No. 7,311,858 B2 “Silicate-based yellow-green phosphors” (assigned to Intematix Corp.). The phosphor can also comprise an aluminate-based material such as is taught in co-pending patent application US2006/0158090 A1 “Novel aluminate-based green phosphors” and patent U.S. Pat. No. 7,390,437 B2 “Aluminate-based blue phosphors” (assigned to Intematix Corp.), an aluminum-silicate phosphor as taught in co-pending application US2008/0111472 A1 “Aluminum-silicate orange-red phosphor” or a nitride-based red phosphor material such as is taught in co-pending United States patent applications US2009/0283721 A1 “Nitride-based red phosphors” and US2010/074963 A1 “Nitride-based red-emitting in RGB (red-green-blue) lighting systems”. It will be appreciated that the phosphor material is not limited to the examples described and can comprise any phosphor material including nitride and/or sulfate phosphor materials, oxy-nitrides and oxy-sulfate phosphors or garnet materials (YAG).

FIG. 4 is a schematic illustrating the principle of operation of the LED lamp 14. In operation, light 38 generated by the LEDs 20, which is of a first wavelength range λ₁ (blue in this example), is coupled into the edges of the light guide 18 and is guided within the entire volume of the light guide 18 by total internal reflection. For the sake of brevity light 38 generated by the LED, that is unconverted light, will be termed “LED Light”. Since there is no air-gap between the phosphor material 36 and light guide face and since the printed phosphor material feature has a similar or higher index of refraction compared with the light guide, LED light 38 that strikes the face of the light guide at locations corresponding to a phosphor feature 36 will be typically be extracted from the light guide and enter into the feature. A proportion of the LED light 36 extracted from the light guide will be absorbed by the phosphor material 36 and converted to light 40 of a second longer wavelength range λ₂ by a process of photoluminescence. Such phosphor generated light will be termed “Phosphor Light”. Light 40 output from the light emitting face of the lamp which comprises the final emission product is a combination of LED light 36 and phosphor light 38. In general lighting applications the emission product 42 will typically be white light and the phosphor material 36 can comprise a blue light excitable phosphor that emits green (510 nm to 550 nm), yellow-green (550 nm to 570 nm), yellow (570 nm to 590 nm), orange (590 nm to 630 nm) or red (630 nm to 740 nm) light or a combination of phosphor materials. The thickness of the phosphor material features and the density (weight loading) of phosphor material per unit area are selected such that only a small proportion (typically less than 10%) of the blue light passes through the phosphor and contributes to the emission product. The correlated color temperature (CCT), measured in degrees Kelvin, of the emission product 42 can be selected by the quantity per unit area (density), thickness and/or composition of the printed phosphor features. In other arrangements the lamp can be configured to produce colored light by appropriate selection of the phosphor material and thickness.

It is believed that on average as few as 1 in 10,000 interactions of a photon with a phosphor material particle results in absorption and generation of photoluminescence light. The majority, about 99.99%, of interactions of photons with a phosphor particle result in scattering of the photon. Due to the isotropic nature of the scattering process on average half of the scattered photons will be in a direction back towards the light guide and can re-enter the light guide. Moreover due to the isotropic nature of photoluminescence light generation, approximately half of the phosphor light 40 will be emitted in a direction towards the light guide and can enter the light guide. As will be described both LED and phosphor light that re-enters the light guide will eventually be emitted from the light emitting face after one or more reflections from the internal faces of the guide or the light reflective surface 34.

Four phosphor features 36a, 36b, 36c, 36d are shown in FIG. 4 and illustrate different mechanisms by which LED and phosphor light 38, 40 is emitted from the light emitting face of the light guide 18. Although not illustrated, LED and phosphor light 38, 40 that strike the internal face of the light guide at angles below the critical angle for internal reflection will also be emitted through the face of the light guide between phosphor features. Phosphor feature 36a illustrates phosphor generated light 40 that is emitted directly from the feature without re-entering the light guide. Phosphor feature 36b illustrates how LED light 38 that is scattered, but not absorbed, by particles of the phosphor material can be emitted from the phosphor feature after being scattered multiple times by the phosphor material. Phosphor feature 36c shows how phosphor light 40 that is generated in a direction towards the light guide can re-enter the light guide and then be emitted from the light guide i) between phosphor features (36b and 36c) and ii) by another phosphor feature 36d.

There are several advantages of the lamp 14 of the invention compared with the known lamps that use a remote phosphor such as those with a light guide and a separate remote phosphor or a light reflective chamber and a window containing the phosphor material. In lamps in accordance with the invention since there is no air gap between light guide and the phosphor material this eliminates optical losses associated with light passing through light guide-air and air-phosphor layer interfaces. Another problem with prior art remote phosphor lamps is that when the blue light is absorbed by the phosphor material and converted to light of another color about 50% of the phosphor light will be emitted back to the light guide or optical chamber. Typically such light is reflected by the light reflective chamber back towards the phosphor layer and then has to pass through the phosphor layer a second time resulting in further optical loss. Additionally some of the phosphor generated light can be absorbed by the LED(s) resulting in additional optical loss. In contrast in the lamp of the invention phosphor generated light that is emitted back towards the light guide will be reflected by the light reflective layer 34 on the bottom face of the light guide and be emitted from the light emitting face of the light guide without being absorbed by the LEDs. Moreover since the total area of the phosphor pattern is very small (typically less than 10%) compared with the area of the light emitting face, most of the light reflected by the reflective layer 34 will pass through the light emitting face of the light guide without having to pass through a phosphor feature for a further time thereby significantly reducing optical loss within phosphor. As a result of the foregoing the optical efficiency of lamps in accordance with the invention are believed to be higher than the known lamps.

For aesthetic considerations and to improve the visual appearance of the lamp 14 in an “off-state” each phosphor feature can optionally be overprinted with a translucent or opaque white ink (non-phosphor) 44 (FIG. 4). Alternatively the phosphor features can be overprinted with a light diffusive material such as a mixture of a light transmissive binder and particles of a light diffusive material such as titanium dioxide (TiO₂). The light diffusive material can also other materials such as barium sulfate (BaSO₄), magnesium oxide (MgO), silicon dioxide (SiO₂) or aluminum oxide (Al₂O₃). In this way, in an off-state, the pattern of phosphor material will appear white in color instead of the phosphor material color which is typically yellow-green, yellow or orange in color. It is further envisioned to overprint the entire light emitting face of the light guide with a light diffusive layer.

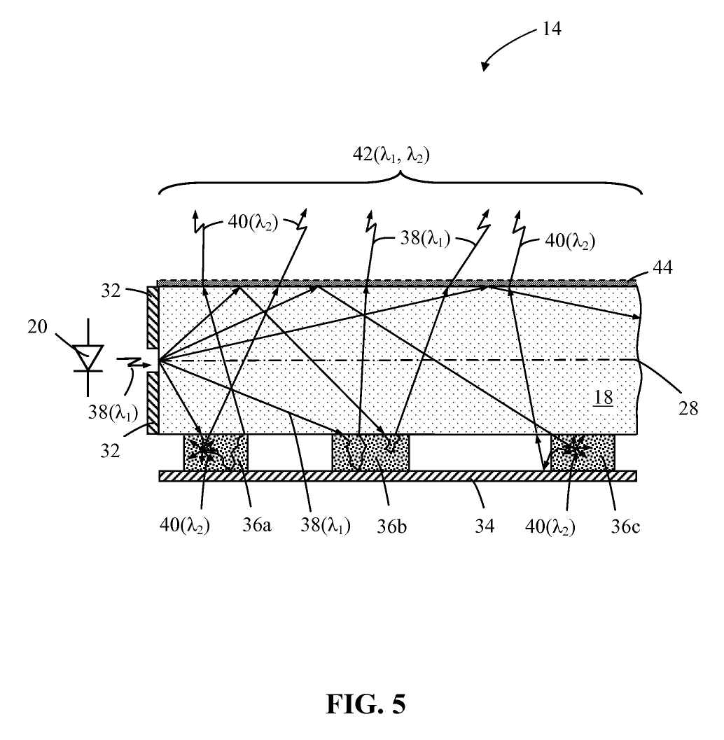

FIG. 5 is a schematic illustrating the principle of operation of a lamp 14 in accordance with another embodiment of the invention. In this embodiment the pattern of phosphor material 36 is provided directly to the face of the light guide 16 that is opposite to the light emitting face (i.e. non-light emitting face) and the light reflective surface 34 laid over the phosphor pattern. Operation of the lamp of FIG. 5 is very similar to that of FIG. 4 and is not described in detail. Three phosphor features 36a, 36b, 36c are shown in FIG. 5 and illustrate examples of different mechanisms by which LED and phosphor light is emitted from the light emitting face of the light guide 18. Although not illustrated both LED and phosphor light 38, 40 that strikes the internal faces of the light guide at angles below the critical angle for internal reflection will also be emitted through the face of the light guide not containing the phosphor features. Phosphor feature 36a illustrates how phosphor light 40 that is generated in a direction towards the light guide is emitted through the light emitting face having travelled through the light guide. Phosphor feature 36a also shows how phosphor light 40 that is generated in a direction away from the light guide is reflected by the light reflective surface back towards and through the light guide. Phosphor feature 36b indicates how LED light 38 extracted by the phosphor feature is scattered by particles of the phosphor material before being reflected by the light reflective surface 34 back towards and through the light guide 18. Phosphor feature 36b also shows LED light 38 that is scattered by particles of the phosphor material back towards and through the light guide. Phosphor feature 36c illustrates phosphor light 40 being emitted from the edge of the phosphor feature that is reflected by the light reflective surface 34 towards and re-enters the light guide before being emitted from the light guide. To mask the phosphor features and to improve the visual appearance of the lamp in an off-state the light emitting face of the light guide can, as indicated by a dashed line in FIG. 5, optionally include a light diffusive layer 44.

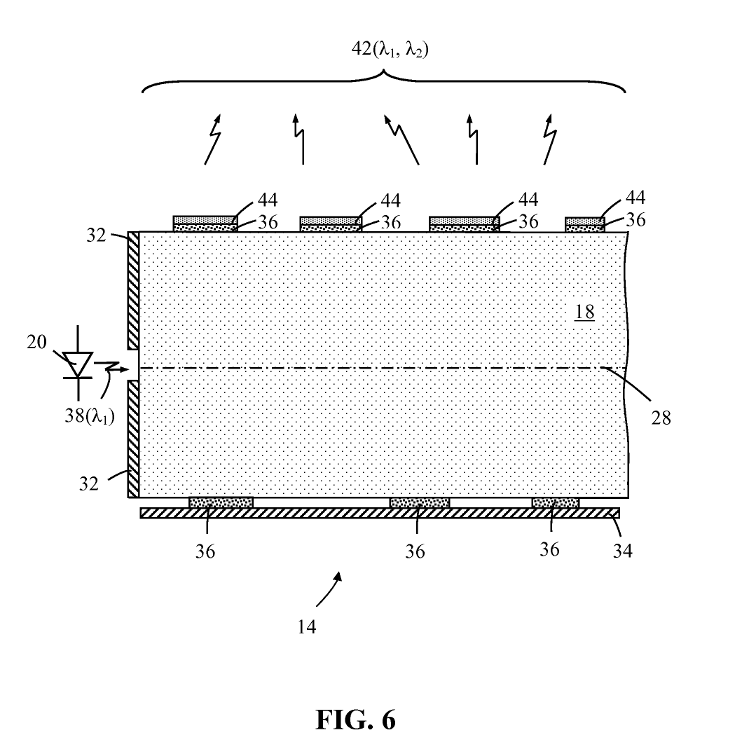

FIG. 6 is a schematic cross sectional view of a lamp in accordance with another embodiment of the invention in which a respective pattern of phosphor features 36 is applied directly to both the light emitting and non-light emitting faces of the light guide 18. In essence the lamp is a combination of the optical configurations of the lamps of FIGS. 4 and 5.

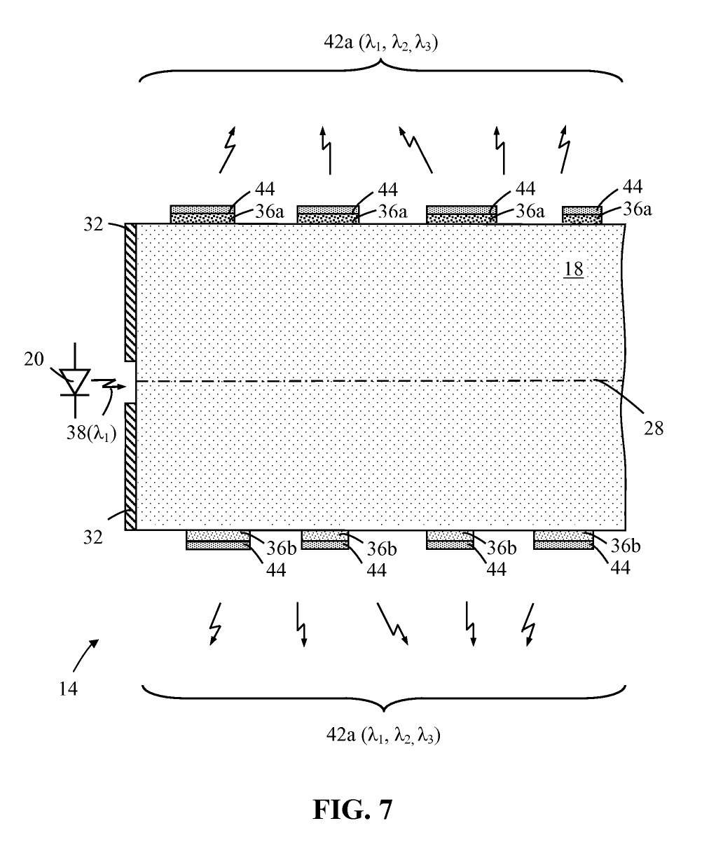

FIG. 7 is a schematic cross sectional view of a lamp in accordance with yet another embodiment of the invention which is configured to emit light from both faces. In the example shown a respective pattern of phosphor features 36a, 36b is applied directly to opposite faces of the light guide 18. The phosphor patterns on each face can be the same such that the lamp has similar emission characteristics from each face. Alternatively differing patterns of phosphor features cab be used on each face to achieve different emission products (intensity, color) 42a, 42b from each face. The configuration of the phosphor features 36, namely their size, spacing and position, will determine the amount of light extracted from the light guide and will largely determine the emission intensity profile over the face. The composition, thickness and density loading of the phosphor features will largely determine the color of emitted light. Although different phosphor materials 36a, 36b can be used to change the color and/or correlated color temperature (CCT) of light emitted from that face the phosphor material on the opposite face will also contribute light to the emission product. Consequently as indicated in FIG. 7 the emission product 42a, 42b from each face although of differing colors and/or CCT will be composed of LED light (λ₁) and phosphor light (λ₂, λ₃).

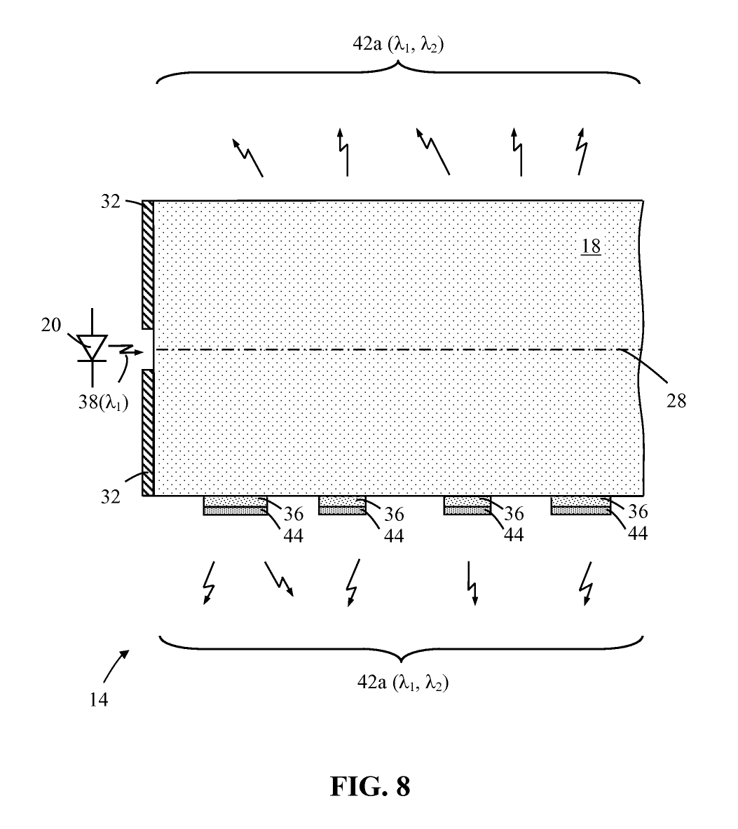

As shown in FIG. 8 it is further envisioned in other embodiments to configure the light guide 18 to have two light emitting faces and to provide the pattern of phosphor material to one face only.

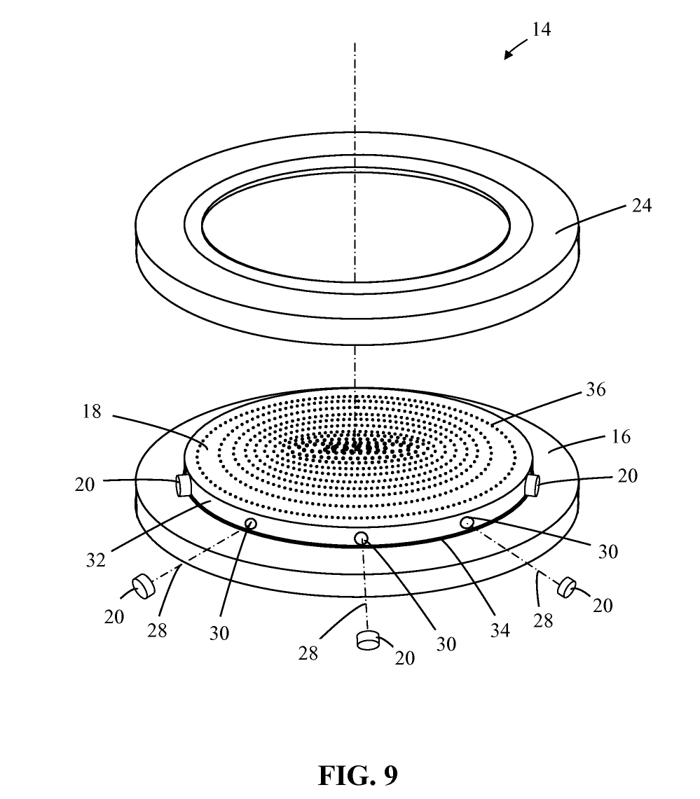

FIG. 9 is a partially exploded perspective view of an LED-based lamp 14 in accordance with a further embodiment of the invention. In this embodiment the light guide 18 comprises a planar circular disc with the LEDs 20 being circumferentially space around the edge of the light guide. Each LED 20 is configured with its emission axis 28 parallel with the plane of the light guide 18. The pattern of phosphor 36 can comprise concentric circular patterns of dots in which the spacing between circles decreases towards the center of the light guide 18. Moreover as shown the size of the dots can additionally increase towards the center of the light guide. Typically the phosphor pattern 36 is configured to minimize variation in the emission intensity over the entire face of the light guide.

The lamp 14 further comprises a thermally conductive circular frame 24, which comprises a wall 23 that extends downward from the upper surface and which is mounted in thermal communication with both the LEDs 20 and the body 16. The frame 16 is configured in conjunction with the body 16 to house the LEDs 20 and to function as a heat sink to thermally manage heat generated by the lamp 14.

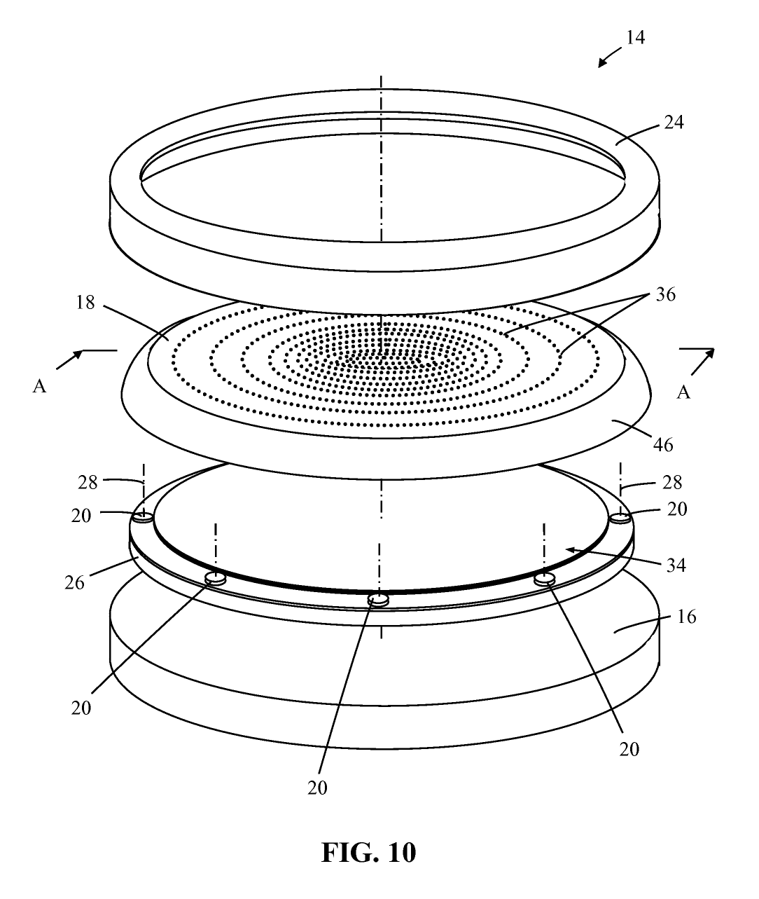

FIG. 10 is a partially exploded perspective view of an alternate LED-based lamp 14 in accordance with a further embodiment of the invention in which the LEDs 20 are configured as a circular array. In this embodiment, each LED 20 is configured with its emission axis 28 perpendicular to the plane of the light guide 18, with light being coupled into the rear face (i.e. the face opposite the front light emitting face) of the light guide 18. The light guide 18 comprises a planar circular disc with the LEDs 20 being circumferentially space around the edge of the light guide, where the pattern of phosphor 36 can comprise concentric circular patterns of dots in which the spacing between circles decreases towards the center of the light guide 18. In addition, the size of the dots can additionally increase towards the center of the light guide. The phosphor pattern 36 can be configured to minimize variation in the emission intensity over the entire face of the light guide.

The plurality of LEDs 20 are mounted as an annular array on an annular shaped MCPCB (metal core printed circuit board) 26. As is known a MCPCB comprises a layered structure composed of a metal core base, typically aluminum, a thermally conducting/electrically insulating dielectric layer and a copper circuit layer for electrically connecting electrical components in a desired circuit configuration. The metal core base of the MCPCB 26 is mounted in thermal communication with the base of the body 16 with the aid of a thermally conducting compound such as for example an adhesive containing a standard heat sink compound containing beryllium oxide or aluminum nitride. The circuit board 26 is dimensioned to be substantially the same as the base of the body 16 and may include a central hole corresponding to a circular opening.

The body 16 can be constructed to incorporate and/or act as a heat sink having a planar upper surface and a plurality of heat radiating fins on an opposite face (not shown in the figure). The body 16 is preferably fabricated from aluminum, an alloy of aluminum or any material with a high thermal conductivity (typically κ≧150 Wm⁻¹K⁻¹ and preferably ^{κ}≧200 Wm⁻¹K⁻¹) such as for example copper, a magnesium alloy, a metal loaded plastics material or a thermally conductive ceramic such as aluminum silicon carbide (AlSiC).

The aspect of the various embodiments that pertain to mounting of the LEDs 20 onto a single substrate (MCPCB) 26 provides numerous performance and manufacturing advantages. For example, this approach provides heat management advantages, since the LEDs 20 are mounted in a manner that allows for more effective heat transference efficiencies for conducting heat away from the LEDs 20 and light guide 18 (and the associated phosphor materials in the phosphor pattern 36). In addition, it is noted that there are advantages to having the LEDs provided on a single component, e.g., the MCPCB 26. This is because this type of design minimizes component count in the optics, heat sink and electronics thereby minimizing costs. Therefore, increased optical efficiency as well as thermal behavior combine to enable a reduction in the LED component count, heat sink area and size of power supply. All of this results in a lamp of lower cost and higher efficiency.

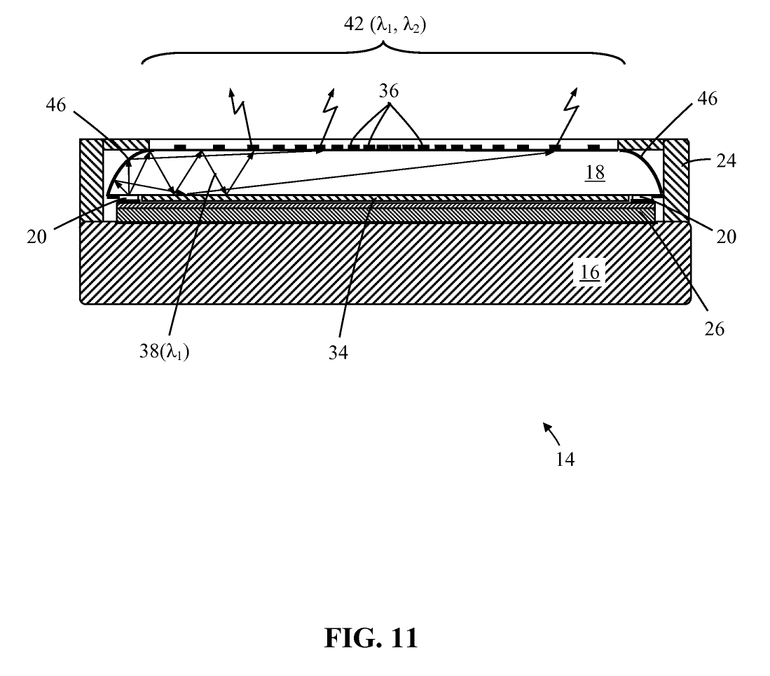

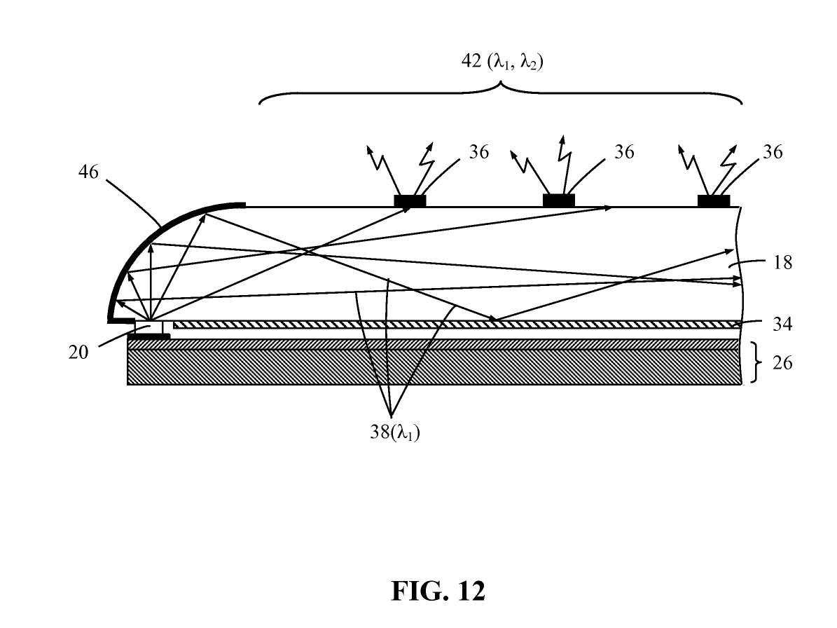

Since the emission axis 28 of the LEDs 20 in this embodiment is perpendicular to the plane of the light guide 18, additional measures can be taken to direct light generated by the LEDs 20 towards the phosphor pattern 36 on the light guide 18. In some embodiments, the edge of the light guide 18 is configured such that light emitted by the LEDs are redirected inwardly through the light guide. For example, the edge of the light guide can be configured to be curved or rolled from the rear face to the front face, and can be covered with a light reflective material 46 such as chromium or aluminum. FIGS. 11 and 12 are schematics illustrating the principle of operation of a lamp 14 in accordance with this embodiment of the invention. In this embodiment, the emission axis 28 of the LEDs 20 are perpendicular to the plane of the light guide 18 and are directly in-line with the curved edge of the light guide 18, causing the blue light generated by the LEDs 20 to strike the reflective surface of the curved edge. At least some of the blue light 38 from the LEDs 20 is redirected at various angles more parallel to the plane of the light guide 18, so that the light travels away from the edge of the light guide 18. Reflective material 34 may be utilized to efficiently guide the light 38 along the plane of the light guide 18. The redirected light 38 is therefore provided through the light guide 18 to the pattern of phosphor material 36, to generate photoluminescent light which is combined with at least some of the blue light to form the final emission product 42.

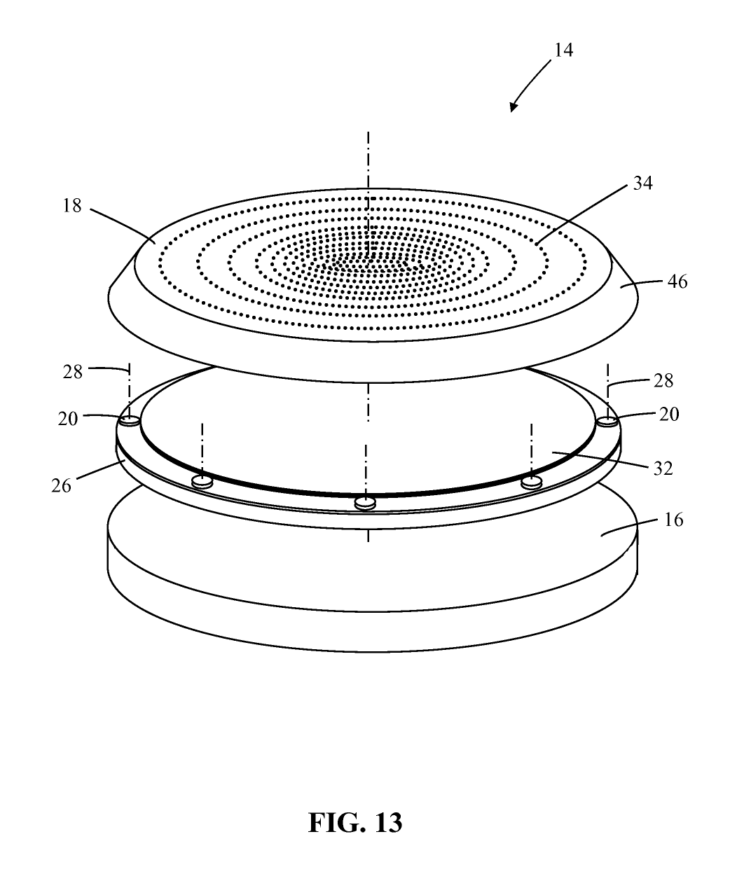

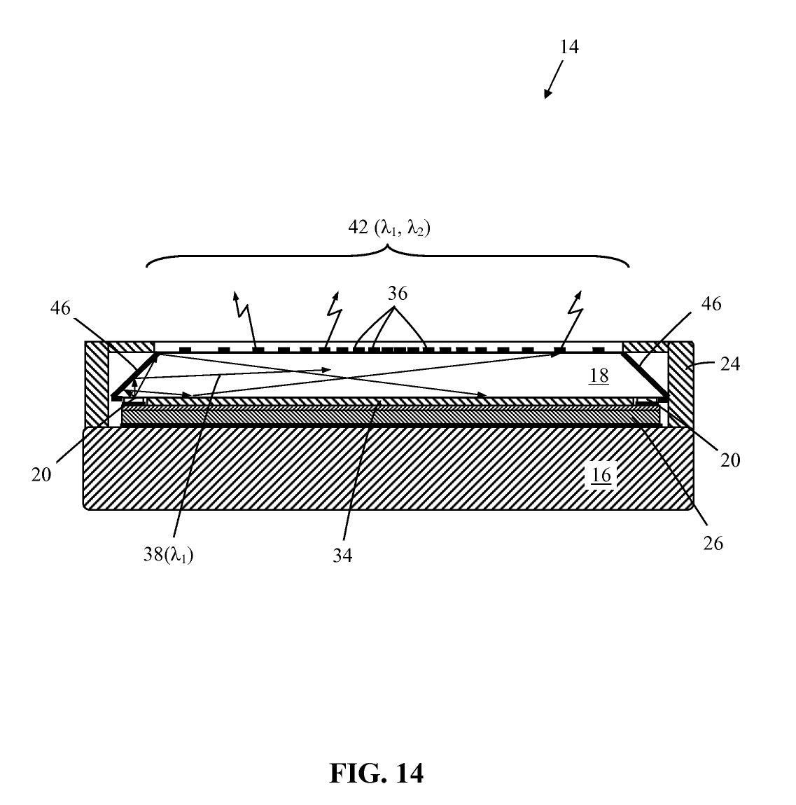

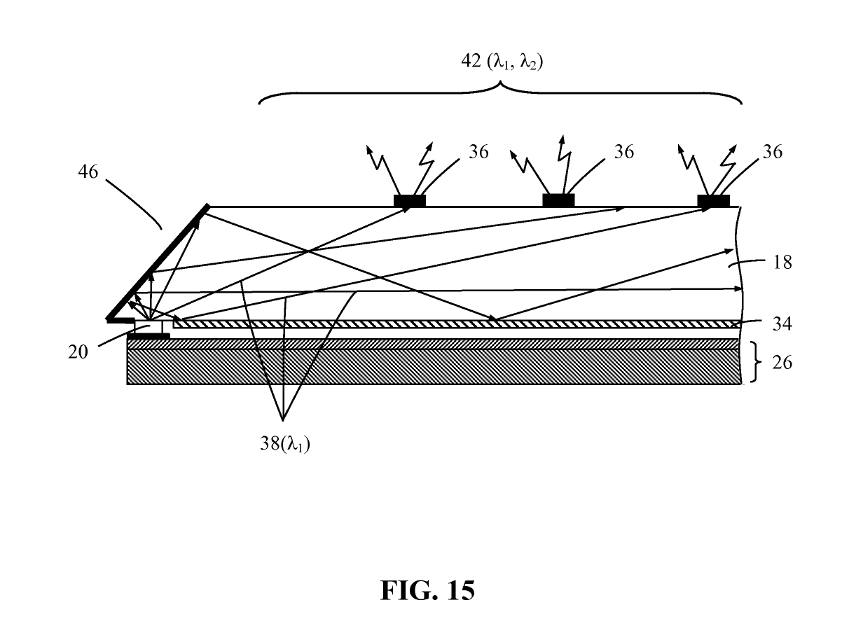

FIG. 13 is a partially exploded perspective view of another embodiment of an LED-based lamp 14, in which the edge of the light guide 18 is slanted inwardly from the rear face to the front face as a beveled edge, and is covered with a light reflective material 46 such as chromium, aluminum or a light reflective paper or plastics material. This approach is different from the approach of FIGS. 10-12 in that the edge of the light guide 18 is slanted/beveled with a straight edge rather than having a curved or rolled edge. FIG. 14 and FIG. 15 are schematics illustrating the principle of operation of a lamp 14 in accordance with this embodiment of the invention. In this embodiment, the emission axis 28 of the LEDs 20 is perpendicular to the plane of the light guide 18 and is directly in-line with the slanted edge of the light guide 18, causing the blue light generated by the LEDs 20 to strike the reflective surface 46 of the slanted edge. The light 38 from the LEDs 20 is redirected at various angles more parallel to the plane of the light guide 18, so that the light travels away from the edge of the light guide 18. It will be appreciated that the light reflective edge(s) further prevent light being emitted from the front face of the light guide that would otherwise be transmitted directly through the guide. Reflective material 34 may be utilized to guide the light 38 along the plane of the light guide 18.

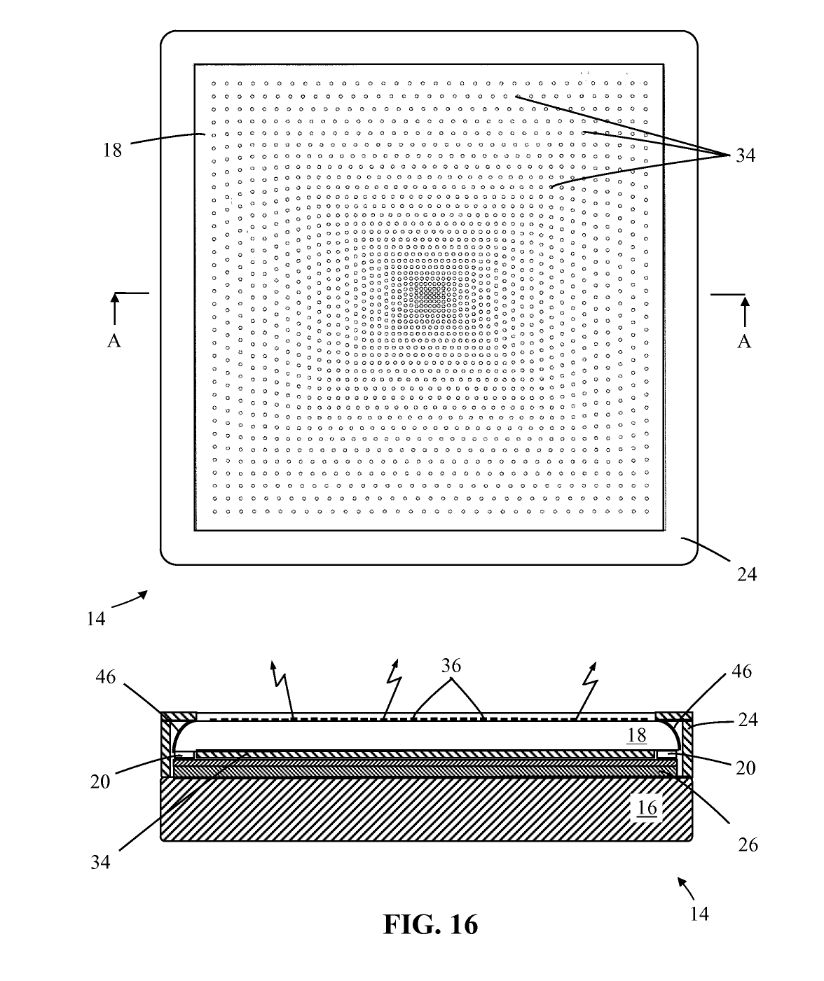

Similar approaches can be taken to configure the placement of LEDs for any of the other embodiments described above. For example, the rectangular lamp of FIG. 3 may be modified, as illustrated in FIG. 16, by placing the LEDs 20 such that each LED 20 is configured with its emission axis 28 perpendicular to the plane of the light guide 18, with light being coupled into the rear face (i.e. the face opposite the front light emitting face) of the light guide 18. The LEDs 20 are mounted on a MCPCB 26, which is configured to be in thermal contact with body 16. The body 16 can be constructed to incorporate and/or act as a heat sink having a planar upper surface and a plurality of heat radiating fins 22 on an opposite face.

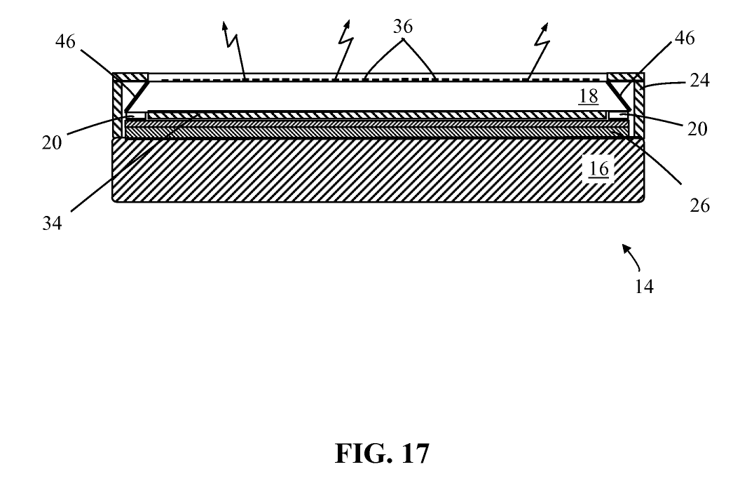

In the embodiment of FIG. 16, the edge of the light guide 18 is curved or rolled inwardly from the rear face to the front face and is covered with a light reflective material 46 such as chromium, aluminum or a light reflective paper or plastics material. In the embodiment of FIG. 17, the edge of the light guide 18 is slanted/beveled inwardly from the rear face to the front face and is covered with a light reflective material 46 such as chromium or aluminum. In either embodiment, the light 38 from the LEDs 20 are redirected from an emission axis perpendicular to the plane of the light guide 18 to an axis that is more parallel to the plane of the light guide 18.

Locating the LEDs around the periphery of the light guide and being configured to emit into the face of the light guide is considered inventive in its own right. As noted above, this type of configuration provides heat management advantages and also minimizes component count in the optics, heat sink and electronics, thereby minimizing manufacturing costs.

While the above embodiments are described in the context of remote-phosphor LED lamps, it will be appreciated that such an arrangement could also be employed using non-remote-phosphor lamps that employ white LEDs. Such white LEDs can be formed using powdered phosphor material that is mixed with a light transmissive liquid binder, typically a silicone or epoxy, and where the mixture is applied directly to the light emitting surface of the LED die such that the LED die is encapsulated with phosphor material.

Since the phosphor material is not remote to the LED, this approach does not need phosphor materials deposited onto the light guide to generate white light. However, light extracting features will still be provided onto at least one surface of the light guide to allow the white light generated by the white LEDS to be emitted from the light guide. These light extracting features are configured to cause a difference in the refractive properties of the light extracting features as compared to the light guide itself. This allows white light emitted from the LEDs to escape the light guide if directed at the light extracting features at appropriate emission angles.

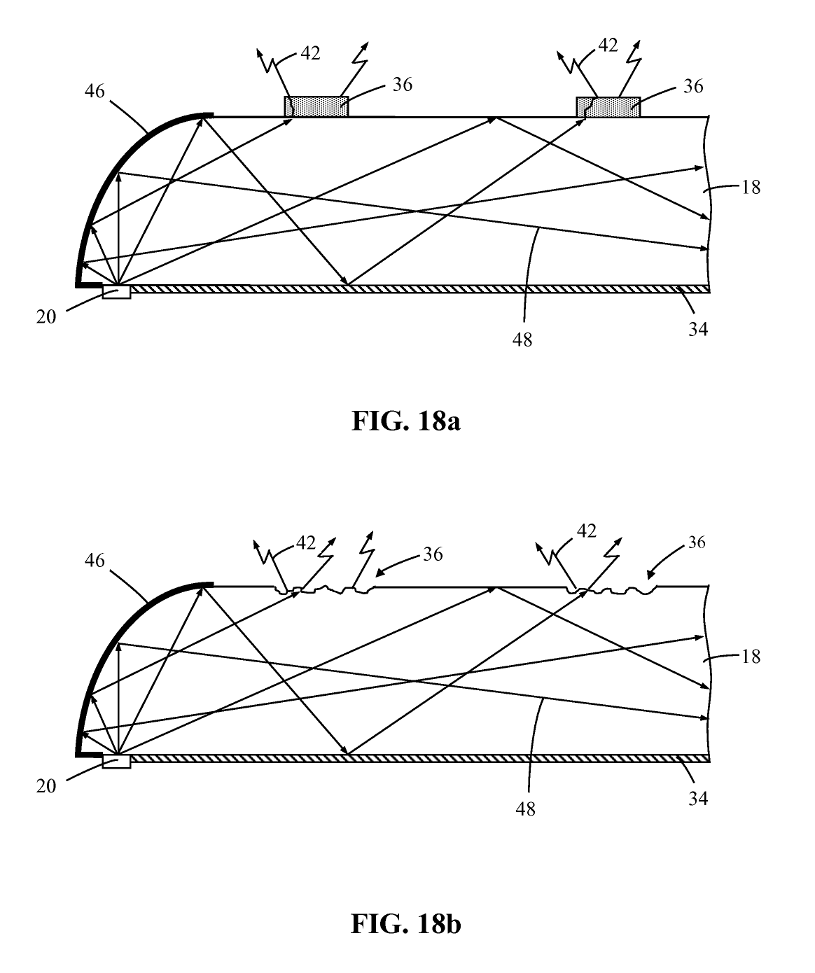

Any suitable approach can be taken to provide light extracting features onto the light guide. FIG. 18a illustrates one example approach in which the light extracting features 36 comprise an overprinted substance, such as a translucent or opaque white ink (non-phosphor) or a light diffusive material such as a mixture of a light transmissive binder and particles of a light diffusive material such as titanium dioxide (TiO₂). The light diffusive material can also other materials such as barium sulfate (BaSO₄), magnesium oxide (MgO), silicon dioxide (SiO₂) or aluminum oxide (Al₂O₃). The overprinted substance that forms the light extracting features 36 causes a sufficient difference in the respective indices of refraction compared to the light guide 18 such that light 48 emitted from LED 20 and redirected by reflective material 46 at appropriate angles can escape the light guide 18 to form the light emission product 42.

FIG. 18b illustrates another example approach, in which the surface of the light guide is modified to form the light extracting features 36. Any suitable approach can be taken to modify the surface of the light guide 18. For example, etching, abrasion, roughing, scoring, ablating (e.g., laser ablating) or scribing can be used to change the surface properties of the light guide to form the light extracting features 36. The surface of the light guide needs to be modified sufficiently to permit light 48 emitted from LED 20 and redirected by reflective material 46 to the light extracting features 36 to escape the light guide 18 to form the light emission product 42.

FIGS. 18c and 18d illustrate yet another approach, in which the light guide is manufactured with integrally formed light extracting features 36. The approach of FIG. 18c implements the light extracting features 36 as indentations or depressions that are molded or otherwise manufactured within the light guide 18. The depressions forming the light extracting features 36 may be configured as any suitable shape. For example, the light extracting features 36 can be molded into the light guide 18 shaped as channels, grooves, concave regions, or holes of any suitable size and depth. The approach of FIG. 18d implements the light extracting features 36 as raised portions on the surface that are molded or otherwise manufactured onto the light guide 18. The raised portions forming the light extracting features 36 may be configured as any suitable shape. For example, the light extracting features 36 can be molded into the light guide 18 shaped as ridges, domes, pyramids, or linear mounds of any suitable height and length.

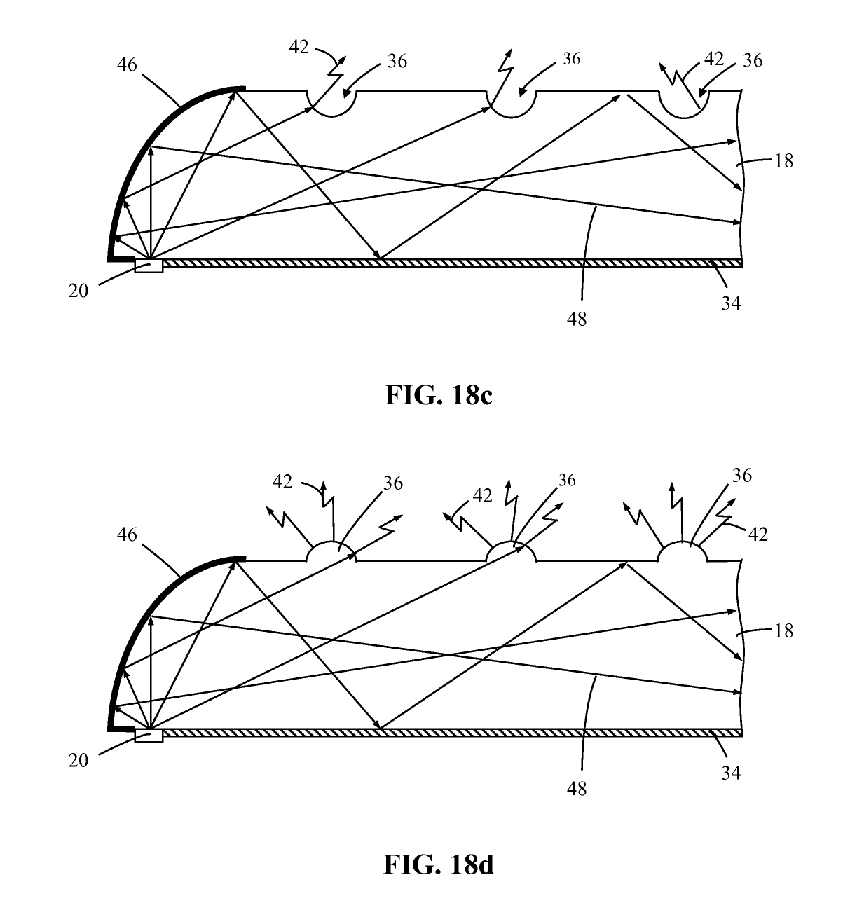

FIG. 19 shows plan and sectional views of an LED lamp 14 in accordance with another embodiment of the invention. LED lamp 14 is generally organized as a cylindrical structure, having a lower body 16 that is formed as a linearly extending partial-cylindrical shape between two circular end units 48. The body 16 can be of a hollow or solid construction and can be fabricated from any suitable sheet material, such as sheet metal, cast metal or a molded plastics material. A light guide 18 is also formed as a linearly extending partial-cylindrical shape between the two circular end units 48. The light guide 18 can be constructed from any material which is transmissive to visible light and typically comprises a sheet plastics material such as a polycarbonate, an acrylic or a glass.

LEDs 20 are mounted in the end units 48. Each LED 20 is configured with its emission axis 28 parallel with the plane of the light guide 18. A light reflective (mirrored) coating 32, such as for example a metal foil, is provided to reflect blue light from the LEDs into the light guide 18. To prevent the escape of blue light, the inner surface of the lower body 16 can also include a light reflective coating 32.

The pattern of phosphor 36 on the light guide 18 can comprise parallel patterns of dots in which the spacing between parallel patterns decreases towards the center of the light guide 18. Moreover, the size of the dots can additionally increase towards the center of the light guide. Typically the phosphor pattern 36 is configured to minimize variation in the emission intensity over the entire face of the light guide.

The blue light 38 from the LEDs 20 is emitted at various angles along the plane of the light guide 18, so that the light travels away from the ends of the light guide 18. Reflective material 32 may be utilized to efficiently guide the light 38 along the plane of the light guide 18. The light 38 is provided through the light guide 18 to the pattern of phosphor material 36, to generate photoluminescent light which is combined with the remaining blue light to form the final emission product 42.

The combination of the lower body 16 and the light guide 18 forms the generally cylindrical shape of the lamp 14. The specific proportion of the light guide 18 relative to the lower body 16 is selected to obtain desired light quantity and shaping requirements of the lamp 14. For example, a lamp 14 that is intended to provide greater light emission angles may be configured to have a relatively greater proportion of the cylindrical shape of the lamp 14 formed from the light guide 14, whereas a lamp that intended to provide more focused light emission angles may be configured to have a relatively smaller proportion of the cylindrical shape of the lamp 14 formed from the light guide 14.

Emission Intensity Profile

As described the emission intensity profile of the lamp will depend at least in part on the position, size and spacing of the phosphor features whilst the color and/or color temperature of the emission product will be dependent on the composition, thickness and density loading of the phosphor features. Co-pending United States patent application publication US 2010/0027293, the specification of which is incorporated herein by way of reference thereto, teach a light emitting panel comprising a polygonal-shaped light guide having at least one light source associated with each truncated corner and a pattern of light extracting features on at least one face of the light guide that is configured to promote a substantially uniform emission light over the entire face of the light guide. Similarly where a substantially uniform emission intensity profile is required the pattern of phosphor features 36 can be configured such as to reduce, preferably minimize, the variation in emitted light intensity over substantially the entire surface of the light emitting face of the light guide. In such lamps the pattern of phosphor features can be configured, at least in part, in dependence on the light intensity distribution within the light guide which can be calculated or derived empirically. Since the light distribution within the light guide will typically be non-uniform and will vary with distance from each LED, the position, spacing, size, shape and/or density of features necessary to achieve a substantially uniform emission intensity of light can vary across the light guide. For example the spacing of features (the closer the spacing of features the more light will be extracted per unit area in that region) will depend on distance from LEDs and will typically reduce as the intensity falls with increasing distance from LED. Alternatively and/or in addition the size and/or shape of the phosphor features can depend upon the distance from LED. Moreover, the pattern of phosphor features can also be configured such that the number of phosphor features per unit area increases in dependence on distance from LED. Depending on application other patterns of phosphor features will be derivable by those skilled in the art.

Graded Phosphor Patterns

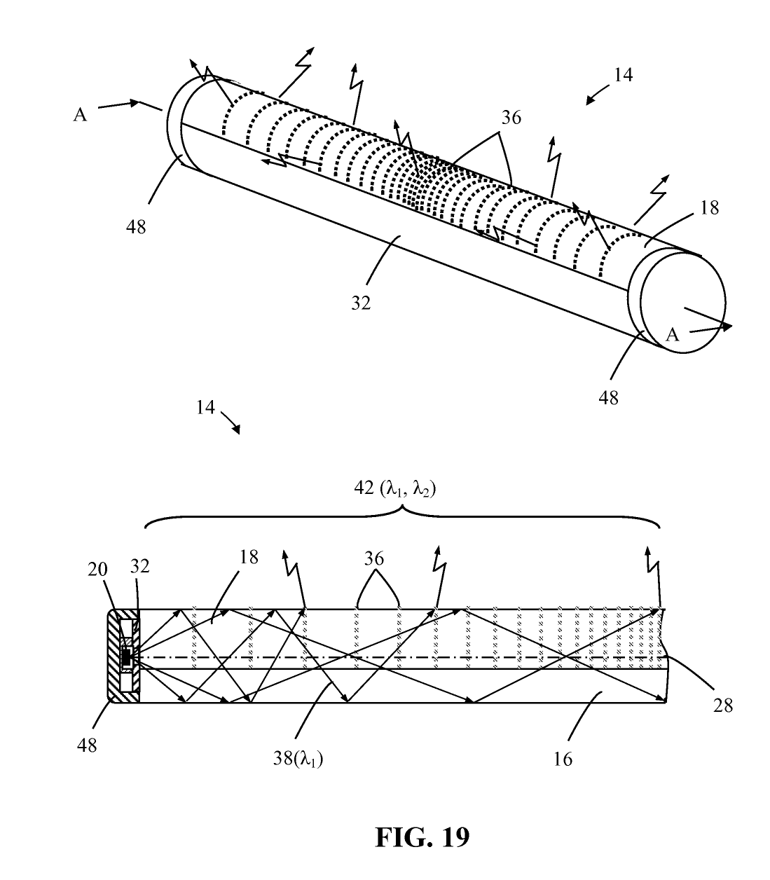

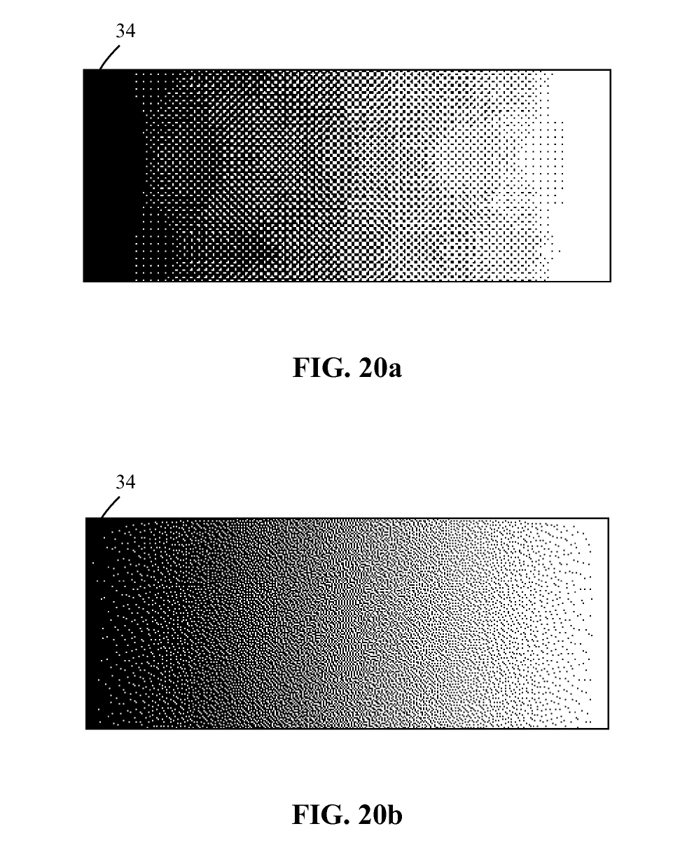

It is further envisioned to print the phosphor pattern as a graded or graduated pattern. FIGS. 20a and 20b respectively show graduated printed phosphor pattern based on AM (amplitude modulated) half tone screening and first order stochastic or FM (frequency modulated) screening. In FIG. 20a the phosphor material is printed as array of regularly spaced dots of varying size. Such a patterning is referred to as AM half tone screening as the amplitude (size) of the dots is modulated (varied) whilst the frequency (spacing) of the dots remains fixed. In FIG. 20b the phosphor ink is printed as a first order stochastic pattern comprising a pseudo-random array of phosphor dots of the same size in which the frequency (density) of dots is varied. Compared with a half tone patterning a first order stochastic pattern can be easier to print since the dot size is fixed and is preferred for screen printing since the dot size can correspond to the screen mesh size. Moreover a stochastic pattern can be preferred where it is required to make multiple print passes or to print patterns comprising two or more phosphor materials since such a random patterning is less sensitive to alignment issues. It is further envisioned to print the phosphor ink using a second order stochastic screening in which both the frequency and amplitude of the dots are modulated.

It will be appreciated that the invention is not limited to the exemplary embodiments described and that variations can be made within the scope of the invention. For example whilst the phosphor pattern has been described as comprising a pattern of dots or pixels in other embodiments it can comprise a pattern of other shaped features including for example lines, triangles, squares, rectangles, hexagons, ellipses or irregular shaped features. It will be appreciated that it is the area and position of the features and not their shape that determines light extraction from the light guide.

Moreover whilst the invention has been described in relation to LED-based lamps the invention also applies to devices based on other solid-state light sources including solid-state lasers and laser diodes.

What is claimed is:

1. A solid-state lamp comprising:
a light guide having at least one light emitting surface;
at least one solid-state light source configured to couple light into the light guide; and
a pattern of light extracting features of at least one photoluminescence material for promoting emission of light from the light guide wherein the pattern of photoluminescence material is deposited directly to at least one surface of the light guide.

2. The lamp of claim 1, wherein the area of all of the photoluminescence material features is selected from the group consisting of: less than about 20% of the area of the light emitting surface and less than about 10% of the area of the light emitting surface.

3. The lamp of claim 1, wherein the pattern of photoluminescence material features is selected from the group consisting of: being provided on the light emitting surface of the light guide, being provided on the face of the light guide opposite the light emitting surface, and being provided on both the light emitting surface and the face of the light guide opposite the light emitting surface.

4. The lamp of claim 1, wherein the pattern of the photoluminescence material features is configured at least in part in dependence on a light intensity distribution within the light guide.

5. The lamp of claim 1, wherein spacing of the photoluminescence material features reduces in dependence with distance from the at least one light source.

6. The lamp of claim 1, wherein sizing of the photoluminescence material features depends at least in part with distance from the at least one light source.

7. The lamp of claim 1, wherein a shape of the photoluminescence material features depends at least in part with distance from the at least one light source.

8. The lamp of claim 1, wherein the number of photoluminescence material features per unit area increases in dependence with distance from the at least one light source.

9. The lamp of claim 1, wherein the photoluminescence material features are selected from the group consisting of: lines; substantially circular features; substantially elliptical features; substantially square features; substantially rectangular features; substantially triangular features; substantially hexagonal features and substantially polygonal shaped features.

10. The lamp of claim 1, wherein the pattern of photoluminescence material is selected from the group consisting of: a first order stochastic pattern comprising a pseudo random array of dots of substantially the same size, a second order stochastic pattern comprising a pseudo random array of dots of varying size and a half tone pattern comprising a regular array of dots of varying size.

11. The lamp of claim 1, further comprising a light reflective surface over substantially the entire opposite face of the light guide.

12. The lamp of claim 1, wherein a pattern of the photoluminescence material features is provided on opposite faces of the light guide such that in operation light is emitted from both faces of the light guide.

13. The lamp of claim 1, wherein the light guide is selected from the group consisting of being: substantially square; substantially rectangular; substantially triangular, substantially hexagonal, polygonal; substantially circular; substantially cylindrical; substantially partially cylindrical; and substantially oval.

14. The lamp of claim 1, wherein the photoluminescence material comprises a phosphor material.

15. The lamp of claim 14, further comprising a light diffusive material overlaying the phosphor material.

16. The lamp of claim 15, wherein the diffusive material is selected from the group consisting of titanium dioxide (TiO₂), barium sulfate (BaSO₄), magnesium oxide (MgO), silicon dioxide (SiO₂) and aluminum oxide (Al₂O₃).

17. The lamp of claim 15, wherein the light diffusive material is selected to improve an off-state white appearance of the lamp.

18. The lamp of claim 1, wherein the at least one solid-state light source is configured such that its emission axis is substantially perpendicular to an axis or plane of the light guide.

19. The lamp of claim 18, and further comprising a reflector associated with an edge of the light guide to redirect light emitted by the at least one solid-state light source from a direction of the emission axis to another direction.

20. The lamp of claim 19, wherein the reflector is defined at least in part by the shape of the edge of the light guide.

21. The lamp of claim 20, wherein the edge of the light guide comprises a shape that is selected from the group consisting of a curved shape, a rolled shape, a slanted shape, and a beveled shape.

22. A solid-state lamp comprising:
a light guide having at least one light emitting surface;
at least one solid-state light source configured to couple light into the light guide;
the at least one solid-state light source having an emission axis that is substantially perpendicular to an axis or plane of the light guide; and
a pattern of light extracting features for promoting emission of light from the light guide.

23. The lamp of claim 22, wherein multiple ones of the at least one solid-state light source is mounted onto a common substrate.

24. The lamp of claim 22, and further comprising a reflector associated with an edge of the light guide to redirect light emitted by the at least one solid-state light source from a direction of the emission axis to another direction.

25. The lamp of claim 24, wherein the reflector is defined at least in part by the shape of the edge of the light guide.

26. The lamp of claim 25, wherein the edge of the light guide comprises a shape that is selected from the group consisting of a curved shape, a rolled shape, a slanted shape, and a beveled shape.

27. The lamp of claim 22, the pattern of light extracting features is formed by depositing a material onto the light guide.

28. The lamp of claim 27, wherein the material is selected from the group consisting of: titanium dioxide (TiO₂), barium sulfate (BaSO₄), magnesium oxide (MgO), silicon dioxide (SiO₂) and aluminum oxide (Al₂O₃).

29. The lamp of claim 22, wherein the pattern of light extracting features is integrally formed into the light guide.

30. The lamp of claim 29, wherein the pattern of light extracting features is selected from the group consisting of: indentations, depressions, raised portions, channels, grooves, concave regions, holes, ridges, domes, pyramids, or linear mounds.

31. The lamp of claim 22, wherein the pattern of the light extracting features is formed by modifying a surface of the light guide.

32. The lamp of claim 31 in which the surface is configurable by etching, abrasion, roughing, scoring, ablating or scribing.

33. The lamp of claim 22, wherein the light extracting features comprise a photoluminescence material.

34. The lamp of claim 33, further comprising a light diffusive material overlaying the photoluminescence material.

35. The lamp of claim 34, wherein the diffusive material is selected from the group consisting of: titanium dioxide (TiO₂), barium sulfate (BaSO₄), magnesium oxide (MgO), silicon dioxide (SiO₂) and aluminum oxide (Al₂O₃).

36. The lamp of claim 34, wherein the light diffusive material is selected to improve an off-state white appearance of the lamp.

37. The lamp of claim 22, wherein the pattern of the light extracting features is configured at least in part in dependence on a light intensity distribution within the light guide.

38. The lamp of claim 22, wherein the spacing of the light extracting features reduces in dependence with distance from the at least one light source.

39. The lamp of claim 22, wherein the size of the light extracting features depends at least in part with distance from the at least one light source.

40. The lamp of claim 22, wherein the shape of the light extracting features depends at least in part with distance from the at least one light source.

41. The lamp of claim 22, wherein the number of photoluminescence material features per unit area increases in dependence with distance from the at least one light source.
